(19) United States
(12) Patent Application Publication
(10) Pub. No.: US 2018/0224884 A1
(43) Pub. Date: Aug. 9, 2018

(54) INFORMATION PROCESSING APPARATUS AND INFORMATION PROCESSING METHOD

(71) Applicant: FUJITSU LIMITED, Kawasaki-shi (JP)

(72) Inventor: Hikari Oshima, Kawasaki (JP)

(73) Assignee: FUJITSU LIMITED, Kawasaki-shi (JP)

(21) Appl. No.: 15/881,837

(22) Filed: Jan. 29, 2018

(30) Foreign Application Priority Data
Feb. 3, 2017 (JP) 2017-018821

(51) Int. Cl. G06F 1/12

(52) U.S. Cl. CPC G06F 1/12; G06F 1/14

(57) ABSTRACT

An information processing apparatus includes a first circuit configured to operate in synchronization with a clock time of the first circuit, a second circuit configured to operate in synchronization with a clock time of the second circuit and control the first circuit, a first memory, and a first processor coupled to the memory and configured to when a first clock time of the first circuit is synchronized with a second clock time of the second circuit or a reference clock time, calculate a coefficient for clock time correction according to change in a difference between at least one of the first clock time and the second clock time and the reference clock time, and correct clock time information of logs collected by the second circuit based on the coefficient.

### CROSS-REFERENCE TO RELATED APPLICATION

This application is based upon and claims the benefit of priority of the prior Japanese Patent Application No. 2017-18821, filed on Feb. 3, 2017, the entire contents of which are incorporated herein by reference.

### FIELD

The embodiments discussed herein are related to an information processing apparatus and an information processing method.

### BACKGROUND

In the case of monitoring and controlling plural server systems like plural system boards each individually including firmware or partition, a system for control is set and activation, shutdown, monitoring of errors, and collection of logs by the system for control are carried out.

In activation of each server system, at the time of shutdown, and at the time of error detection, a log output unit of each server system dumps logs of a detected error and processing operation and the system for control collects the logs of each server system through a local area network (LAN), for example. In the dump of such logs, each server system and the system for control measure clock time information of each log based on a time clock that operates in synchronization with a real time clock internally possessed by a respective one of the systems. Therefore, if synchronization of the clock times measured by the respective server systems and the system for control is not established, the case in which inversion of the clock time and so forth occur in collected logs and it is difficult to ensure the consistency of the logs possibly occurs. Thus, accurately establishing the synchronization of the clock time among the respective systems is a problem.

There is the following technique as a method for clock time synchronization among terminals in a terminal group (for example, Japanese Laid-open Patent Publication No. 2008-262292). Based on the difference between a difference in the transmission clock time from one of terminals given to plural pieces of data sent from the one of the terminals to a server and a difference in the reception clock time of the plural pieces of data from the one of the terminals received by the server, deviation of the clock time among the terminals in the terminal group is detected and the clock time of each terminal is corrected.

### SUMMARY

According to an aspect of the embodiments, an information processing apparatus includes a first circuit configured to operate in synchronization with a clock time of the first circuit, a second circuit configured to operate in synchronization with a clock time of the second circuit and control the first circuit, a first memory, and a first processor coupled to the memory and configured to when a first clock time of the first circuit is synchronized with a second clock time of the second circuit or a reference clock time, calculate a coefficient for clock time correction according to change in a difference between at least one of the first clock time and the second clock time and the reference clock time, and correct clock time information of logs collected by the second circuit based on the coefficient.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a basic configuration example of an information processing apparatus relating to a present embodiment;

FIG. 2 is a diagram illustrating an example of logs recorded in a BMC processing log recording unit in one BMC;

FIG. 3 is a diagram illustrating a configuration example of an information processing apparatus for implementing an operation of a clock time error calculating part in the present embodiment;

FIG. 4 is an operation explanatory diagram of clock time error calculation processing in the embodiment of the information processing apparatus of FIG. 3;

FIG. 5 is an explanatory diagram of calculation operation of a clock time error coefficient;

FIG. 6 is a diagram illustrating a configuration example of an information processing apparatus for implementing an operation of a clock time information modifying part in the present embodiment;

FIG. 7 is an operation explanatory diagram of clock time information modification processing in the embodiment of the information processing apparatus of FIG. 6;

FIGS. 8A and 8B are a relationship diagram between a reference clock time and an error before correction and a relationship diagram between the reference clock time and a log recorded clock time before correction;

FIGS. 9A and 9B are a relationship diagram between a reference clock time and an error after shift correction and a relationship diagram between the reference clock time and a log recorded clock time after shift correction;

FIGS. 10A and 10B are a relationship diagram between a reference clock time and an error after prediction correction and a relationship diagram between the reference clock time and a log recorded clock time after prediction correction;

FIG. 11 is a diagram illustrating operation example 1;

FIG. 12 is a diagram illustrating operation example 2;

FIG. 13 is a diagram illustrating an example of log time series before clock time correction corresponding to operation example 2;

FIG. 14 is a diagram illustrating an example of log time series after clock time correction corresponding to operation example 2;

FIG. 15 is a flowchart illustrating a processing example in a case in which the clock time error calculation processing that is executed based on the configuration example of FIG. 3 and is illustrated in FIG. 4 is executed as software processing;

FIG. 16 is a flowchart illustrating a processing example in a case in which the clock time information modification processing that is executed based on the configuration example of FIG. 6 and is illustrated in FIG. 7 is executed as software processing;

FIG. 17 is a diagram illustrating a configuration example of another embodiment of an information processing apparatus for implementing an operation of a clock time information modifying part;

FIG. 18 is an operation explanatory diagram of clock time information modification processing in the other embodiment of the information processing apparatus of FIG. 17; and

FIG. 19 is a diagram illustrating one example of a hardware configuration of the information processing apparatus (computer) of FIG. 1 or FIG. 17.

### DESCRIPTION OF EMBODIMENTS

The above-described related art is a technique for establishing clock time synchronization between terminals coupled by a network such as a LAN or the Internet and therefore the unit of the clock time that may be synchronized is on the second time scale at best. On the other hand, the unit of the clock time desired to be synchronized among the above-described respective server systems and system for control is on the order of milliseconds. Thus, there is a problem that it is difficult to apply the above-described related art to such systems.

Therefore, in one aspect of the present disclosure, carrying out clock time correction with higher accuracy for synchronization of the log acquisition clock time in an information processing apparatus including plural devices is intended.

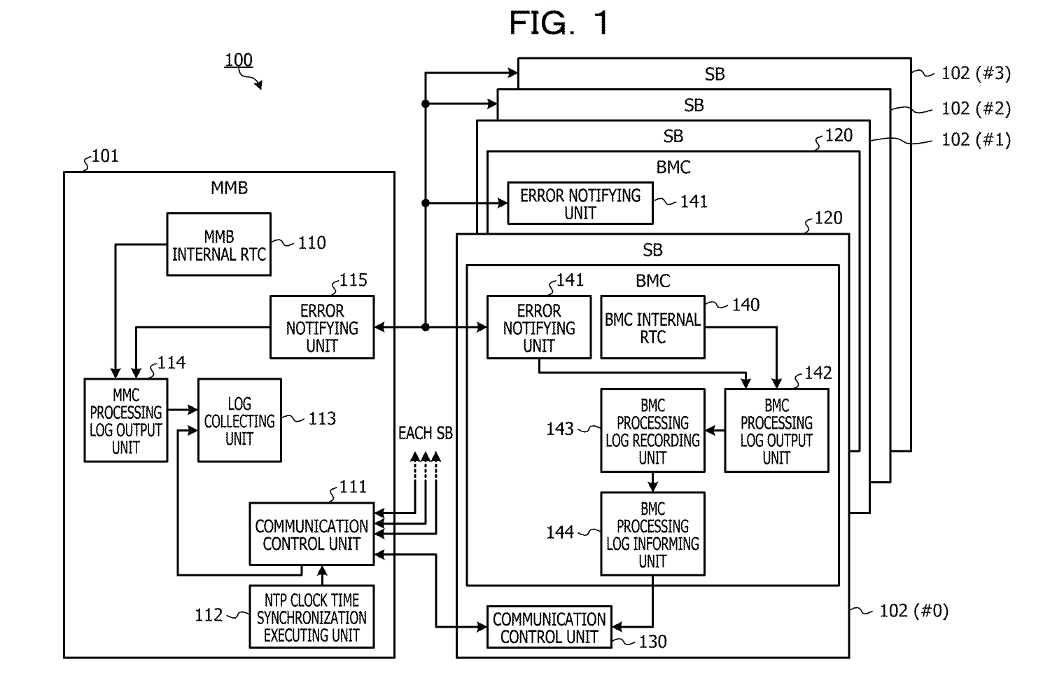

An embodiment of the present disclosure will be described in detail below with reference to the drawings. First, a clock time synchronization method that is normally conceivable will be described. FIG. 1 is a diagram illustrating a basic configuration example of an information processing apparatus relating to a present embodiment.

The information processing apparatus 100 of FIG. 1 includes e.g. four (plural) system boards (hereinafter, represented as “SB”) 102 of #0 to #3 in each of which an arithmetic processing unit (central processing unit (CPU)), a storing unit (memory), and so forth are mounted on a circuit board and that have firmware in the storing unit of a respective one of the SBs. Furthermore, the information processing apparatus 100 includes a control board (management board, hereinafter represented as “MMB”) 101 that monitors and controls these SBs 102.

The SB 102 is equipped with a baseboard management controller (hereinafter, represented as “BMC”) 120 and a communication control unit 130. The BMC 120 carries out activation/shutdown control, monitoring of an error signal, and so forth regarding the SB 102 on which the BMC 120 is mounted. The BMC 120 is provided as a BMC chip and functions are carried out by BMC firmware.

The BMC 120 includes a BMC internal real time clock (RTC) 140, an error notifying unit 141, a BMC processing log output unit 142, a BMC processing log recording unit 143, and a BMC processing log informing unit 144. If an error is detected in the SB 102, the BMC 120 notifies the MMB 101 and the BMCs 120 in the other SBs 102 of the error through the error notifying unit 141 by a signal line for error notification. In the BMC 120, the BMC processing log output unit 142 collects logs in the SB 102 including the error notification in the error notifying unit 141 and records the logs in the BMC processing log recording unit 143. At this time, the BMC processing log output unit 142 measures the clock time that synchronizes with a clock generated by the BMC internal RTC 140 and records the clock time as the above-described log. The BMC processing log informing unit 144 transfers the logs recorded in the BMC processing log recording unit 143 to the MMB 101 through the communication control unit 130. In the case of establishing a partition, plural BMCs 120 may be possessed in one system.

Besides setting of the partition configuration, the MMB 101 carries out activation/shutdown control, monitoring of errors, log collection, and so forth similarly to the BMC 120. The MMB 101 includes an MMB internal RTC 110, a communication control unit 111, a network time protocol (NTP) clock time synchronization executing unit 112, a log collecting unit 113, an MMB processing log output unit 114, and an error notifying unit 115. If an error is detected in the self-device, the MMB 101 notifies the BMCs 120 in the SBs 102 of the error through the error notifying unit 115 by the signal line for error notification. The MMB processing log output unit 114 collects logs in the MMB 101 including the error notification in the error notifying unit 115 and outputs the logs to the log collecting unit 113. At this time, the MMB processing log output unit 114 measures the clock time that synchronizes with a clock generated by the MMB internal RTC 110 and records the clock time as the above-described log. Besides recording the logs output by the MMB processing log output unit 114, the log collecting unit 113 collects and records logs relating to each SB 102 from the BMC processing log informing unit 144 in the BMC 120 of each SB 102 through the communication control unit 130 and the communication control unit 111. The NTP clock time synchronization executing unit 112 synchronizes the clock time measured by each SB 102 with the clock time measured by the MMB 101 periodically (for example, once per day) by operating as an NTP server.

In the basic configuration of the above information processing apparatus 100, if the MMB processing log output unit 114 in the MMB 101 outputs a log, the clock time that synchronizes with the clock of the MMB internal RTC 110 is measured to be recorded as the log. Meanwhile, if the BMC processing log output unit 142 in the BMC 120 of each SB 102 outputs a log, the clock time that synchronizes with the clock of the BMC internal RTC 140 is measured to be recorded as the log. Therefore, if synchronization of the clock times measured by the BMCs 120 of the respective SBs 102 and the MMB 101 is not established, the case in which inversion of the clock time and so forth occur in collected logs and it is difficult to ensure the consistency of the logs possibly occurs. Thus, accurately establishing the synchronization of the clock time among the respective systems is a problem. The accuracy desired in this case is on the order of milliseconds. Here, the clock time that synchronizes with the MMB internal RTC 110 and the clock time that synchronizes with the BMC internal RTC 140 may be synchronized by the NTP clock time synchronization executing unit 112. However, the cycle at which the NTP clock time synchronization executing unit 112 operates is approximately one time per day. Meanwhile, the accuracy of the MMB internal RTC 110 and the BMC internal RTC 140 is approximately 50 parts per million (ppm) (=50/1000000). Therefore, for example, per 256 sec (seconds), an error of approximately ±13 ms (milliseconds) (=256×50/1000000) is caused. To suppress the error within a range of ±0.5 ms, it is desired to carry out polling at an interval of approximately 10 sec per one BMC 120 as synchronization of the NTP. When this operation is carried out regarding plural BMCs 120, the communication load becomes high and it becomes difficult to keep the accuracy as a result. The number of SBs 102 equipped with the BMC 120 often reaches approximately 100. Thus, in this case, to keep the accuracy on the order of milliseconds, the frequency of the polling becomes on the order of one time per approximately 0.1 sec and the communication load becomes high.

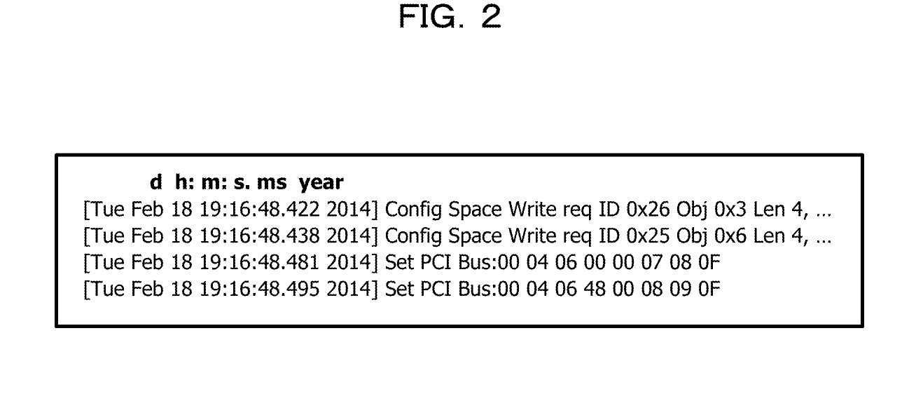

When logs of plural pieces of firmware are analyzed at the time of occurrence of an error or the like, the time series of operation among the pieces of firmware is important. FIG. 2 is a diagram illustrating an example of logs recorded in a BMC processing log recording unit in one BMC. The BMC and the BMC processing log recording unit illustrated in FIG. 2 may be the BMC 120 and the BMC processing log recording unit 143 illustrated in FIG. 1. In activation/shutdown, during which the BMC 120 frequently operates, the amount of processing is very large and processing is executed at intervals on the order of 10 ms. If logs of this amount of processing are generated in plural pieces of firmware (=plural BMCs 120), the accuracy in units of 1 ms is desired to correctly convert the logs into a time series. If the accuracy involves deviation, clock times described in logs are interchanged, for example.

Therefore, in the embodiment described below, the following two kinds of operation are carried out in a rough classification: operation as a clock time error calculating part and operation as a clock time information modifying part. First, the following operation is carried out as the operation of the clock time error calculating part. The MMB (second control device) carries out event notification to each BMC (each first control device) through a signal line for event notification immediately before execution of clock time synchronization (clock time synchronization unit) based on the NTP. Then, for example, in the MMB, the occurrence clock time of the event notification measured by the MMB and the occurrence clock time of the event notification measured by each BMC are compared and thereby the respective clock time errors of the clock times of the respective BMCs with respect to the clock time of the MMB are calculated. Next, as the operation of the clock time information modifying part, the clock time information of logs collected by each BMC is corrected based on a respective one of the clock time errors calculated by the clock time error calculating part. By the above two kinds of operation, clock time correction with higher accuracy is enabled without increasing the number of times of the clock time synchronization of the NTP in the present embodiment.

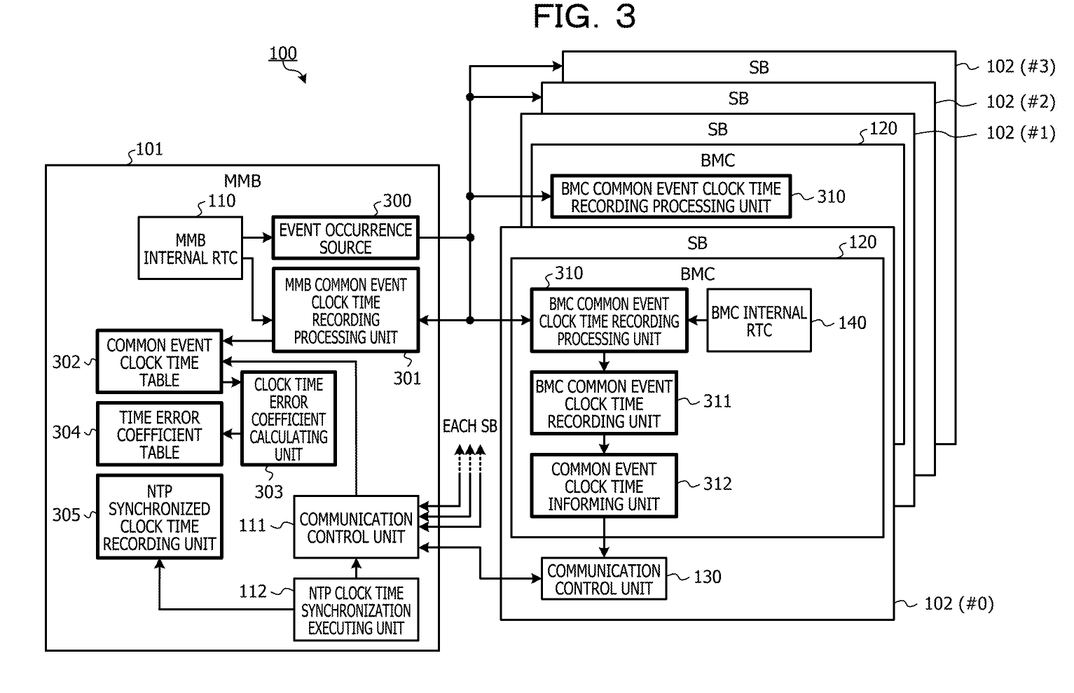

FIG. 3 is a diagram illustrating a configuration example obtained by expanding the information processing apparatus 100 illustrated in FIG. 1 in order to implement the operation of the clock time error calculating part in the present embodiment. The configuration composed of the MMB 101 and the SBs 102 of #0 to #3 is similar to the case of FIG. 1.

In the MMB 101 illustrated in FIG. 3, the MMB internal RTC 110, the communication control unit 111, and the NTP clock time synchronization executing unit 112 are similar to the case of FIG. 1. In addition to this, the MMB 101 in FIG. 3 further includes the following configuration as the configuration corresponding to the clock time error calculating part. First, the MMB 101 includes an event occurrence source 300 (event occurrence unit) that synchronizes with the MMB internal RTC 110 and causes a common event (event) for clock time error measurement to occur and notifies the common event to the MMB 101 itself and the BMC 120 of each SB 102 by a hard signal line for event notification. Furthermore, the MMB 101 includes an MMB common event clock time recording processing unit 301 (common event clock time recording processing unit) for measuring the occurrence clock time of the above-described common event notified by the hard signal line for event notification by a time clock that synchronizes with the MMB internal RTC 110. Moreover, the MMB 101 manages a common event clock time table 302 (common event clock time information storing unit) in which the occurrence clock time of the above-described common event measured in the self-device and the occurrence clock time of the above-described common event measured in each BMC 120 to be notified are recorded. Furthermore, the MMB 101 includes a clock time error coefficient calculating unit 303 that calculates a clock time error coefficient for correcting the clock time error, for example, a coefficient for clock time correction, from the occurrence clock time of the common event measured in the above-described self-device and the occurrence clock time of each common event notified from the BMC 120 of each SB 102. Here, the coefficient for clock time correction corresponds to change in the error of at least one of the clock time of the clock of the MMB 101 and the clock time of the clock of each BMC 120 with respect to the reference clock time. Moreover, the MMB 101 manages a clock time error coefficient table 304 (clock time error coefficient information storing unit) in which each clock time error coefficient calculated by the clock time error coefficient calculating unit 303 is recorded. Furthermore, the MMB 101 includes an NTP synchronized clock time recording unit 305 in which an NTP synchronized clock time in the NTP clock time synchronization executing unit 112 is recorded.

Next, in each SB 102 illustrated in FIG. 3, the communication control unit 130 and the BMC internal RTC 140 in the BMC 120 are similar to the case of FIG. 1. In addition to this, the BMC 120 of each SB 102 in FIG. 3 further includes the following configuration as the configuration corresponding to the clock time error calculating part. First, the BMC 120 includes a BMC common event clock time recording processing unit 310 that measures the occurrence clock time of a common event when the common event is notified (occurs) by a time clock that synchronizes with the BMC internal RTC 140. Moreover, the BMC 120 includes a BMC common event clock time recording unit 311 in which the occurrence clock time of the above-described common event is recorded. Furthermore, the BMC 120 includes a common event clock time informing unit 312 that transmits the occurrence clock time of the common event recorded in the BMC common event clock time recording unit 311 to the MMB 101 through the communication control unit 130 and the communication control unit 111 and causes the occurrence clock time to be recorded in the common event clock time table 302.

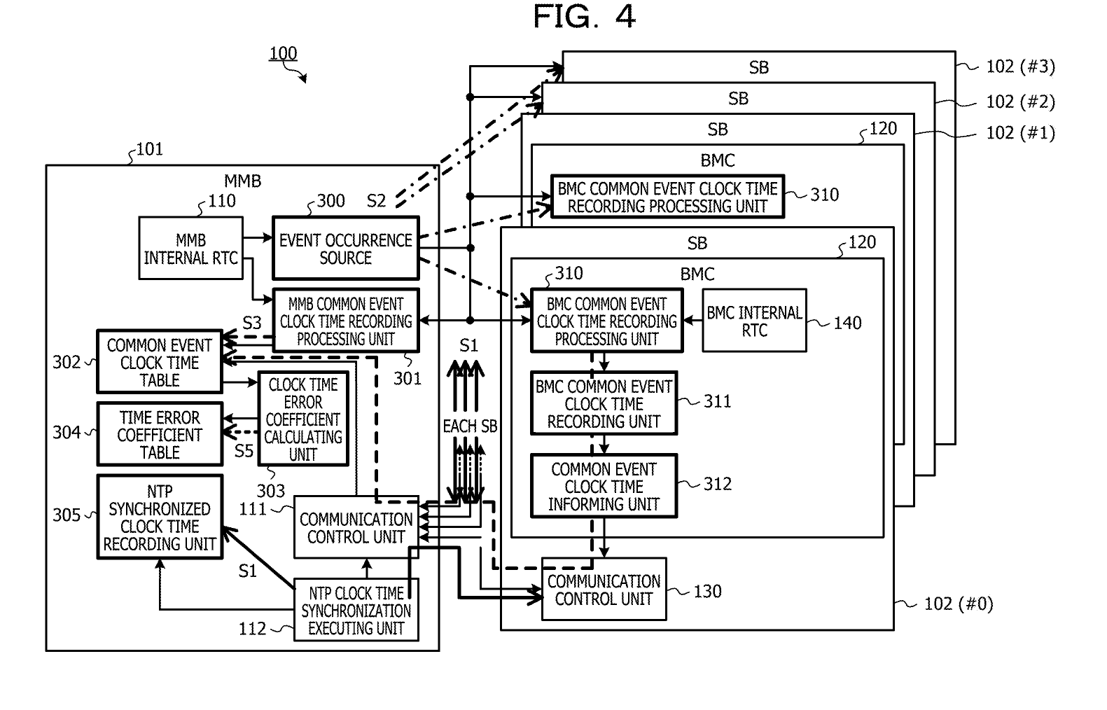

FIG. 4 is an operation explanatory diagram of clock time error calculation processing in the embodiment of the information processing apparatus 100 of FIG. 3.

First, the NTP clock time synchronization executing unit 112 of the MMB 101 establishes clock time synchronization with the time clock that operates in synchronization with the BMC internal RTC 140 in the BMC 120 of each SB 102 or the reference clock time as the NTP server. The synchronization interval may be adjusted to such a degree of time that logs for analysis of an error notified from the error notifying unit 141 (FIG. 1) are output by the BMC processing log output unit 142 (FIG. 1) and at a frequency with which the burden on the MMB 101 does not become excessive. For example, the synchronization interval is one day. The NTP clock time synchronization executing unit 112 records the synchronized clock time in the NTP synchronized clock time recording unit 305 each time (the above corresponds to S1 in FIG. 4).

Next, immediately before (almost simultaneously with) the NTP synchronization by the NTP clock time synchronization executing unit 112, the event occurrence source 300 notifies a common event signal to the MMB 101 itself and the BMC 120 of each SB 102 through the hard signal line for event notification (S2 in FIG. 4).

The MMB common event clock time recording processing unit 301 in the MMB 101 and the BMC common event clock time recording processing unit 310 in the BMC 120 of each SB 102 simultaneously receive the above-described notification of the common event. The BMC common event clock time recording processing unit 310 that has received the notification of the common event measures the occurrence clock time of the common event by the time clock that synchronizes with the BMC internal RTC 140 and dumps the clock time to the BMC common event clock time recording unit 311. The common event clock time informing unit 312 notifies the occurrence clock time of the common event dumped to the above-described BMC common event clock time recording unit 311 to the MMB 101 through the communication control unit 130. The MMB 101 records the occurrence clock time of the common event notified from each BMC 120 in the common event clock time table 302. The MMB common event clock time recording processing unit 301 that has received the notification of the common event measures the occurrence clock time of the common event by the time clock that synchronizes with the MMB internal RTC 110 and records the clock time in the common event clock time table 302 directly (the above corresponds to S3 in FIG. 4).

Next, the clock time error coefficient calculating unit 303 in the MMB 101 carries out the following calculation by using the above-described two occurrence clock times of the common event recorded in the common event clock time table 302. The clock time error coefficient calculating unit 303 calculates each clock time error coefficient relating to the clock time that synchronizes with the BMC internal RTC 140 of each BMC 120 when the clock time that synchronizes with the MMB internal RTC 110 is employed as the basis. Then, the clock time error coefficient calculating unit 303 updates the stored contents of the clock time error coefficient table 304 by each calculated clock time error coefficient (S4 in FIG. 4).

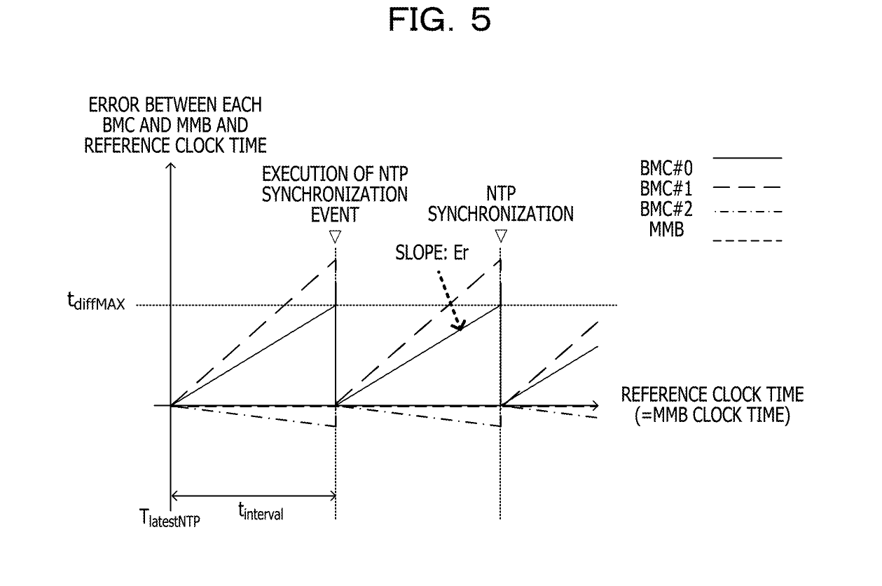

The clock time error coefficient is a coefficient for correcting the clock time information of logs. FIG. 5 is an explanatory diagram of the calculation operation of the clock time error coefficient. The clock time error becomes 0 every time NTP synchronization is carried out. The error caused between the NTP synchronizations, for example, between the synchronization timings, is generated from a frequency error of the BMC internal RTC 140 in each BMC 120 and thus linearly increases over time. The event execution clock time (clock time when the common event is notified) is immediately before the NTP synchronization. Therefore, for example, when the clock time error coefficient of the BMC 120 of #0 is defined as Er (unit: ppm), Er is calculated based on the following expression (1). Here, t_{diffMAX} is the maximum error and tᵢₙₜₑᵣᵥₐₗ is the interval of the NTP clock time synchronization. Furthermore, T_{BMC} is the occurrence clock time of the common event that is recorded in the common event clock time table 302 in FIG. 4 and is notified from the BMC 120 of #0 and T_{MMB} is the occurrence clock time of the common event that is recorded in the common event clock time table 302 and is measured by the MMB 101. Due to this, the clock time error coefficient Er represents the change rate of the clock time error per unit time in the NTP cycle.

$${E}_{r} = \frac{{t}_{diffMAX}}{{t}_{interval}} = \frac{{T}_{BMC} - {T}_{MMB}}{{t}_{interval}} \qquad ( 1 )$$

In view of the occurrence of a deviation value, the procedure of the above S2 to S4 in FIG. 4 is repeated three times and the average of Er is calculated. Thereafter, the clock time error coefficient table 304 is updated once per day (S5 in FIG. 4).

The reason why the clock time error coefficient in the clock time error coefficient table 304 is updated is because the temperature and aging characteristics exist besides the individual difference as causes of the occurrence of the error in the BMC internal RTC 140. The temperature is considered to be steady in all of the MMB 101 and the BMCs 120 in the use environment of the server and the update is carried out at an interval of one day in order to take care of only the aging characteristics (this is because the aging characteristics hardly change within one day).

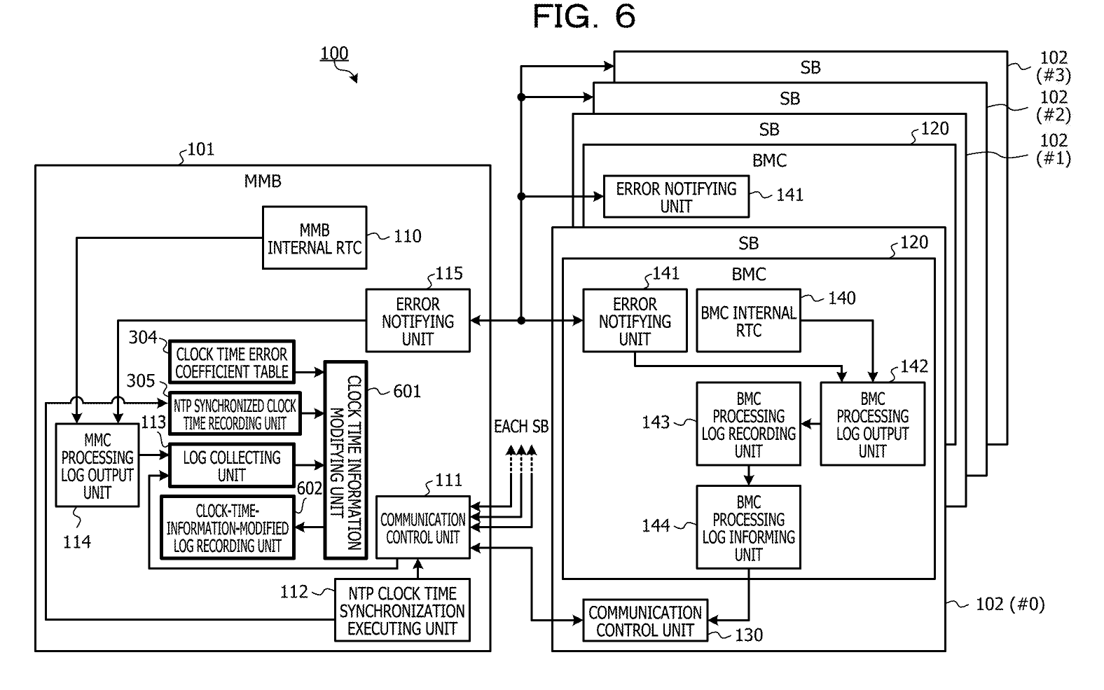

FIG. 6 is a diagram illustrating a configuration example obtained by expanding the information processing apparatus 100 illustrated in FIG. 1 in order to implement the operation of the above-described clock time information modifying part in the present embodiment. The configuration composed of the MMB 101 and the SBs 102 of #0 to #3 is similar to the case of FIG. 1.

In the MMB 101 illustrated in FIG. 6, the MMB internal RTC 110, the error notifying unit 115, the log collecting unit 113, the MMB processing log output unit 114, the NTP clock time synchronization executing unit 112, and the communication control unit 111 are similar to the case of FIG. 1. Furthermore, the MMB 101 includes the clock time error coefficient table 304 and the NTP synchronized clock time recording unit 305 described with FIG. 3. In addition to this, the MMB 101 in FIG. 6 further includes the following configuration as the configuration corresponding to the clock time information modifying part. First, the MMB 101 includes a clock time information modifying unit 601 that modifies the clock time information of logs collected and recorded by the log collecting unit 113. Furthermore, the MMB 101 includes a clock-time-information-modified log recording unit 602 in which logs whose clock time information has been corrected are recorded.

Next, in each SB 102 illustrated in FIG. 6, the communication control unit 130 and the BMC internal RTC 140, the BMC processing log output unit 142, the BMC processing log recording unit 143, and the BMC processing log informing unit 144 in the BMC 120 are similar to the case of FIG. 1.

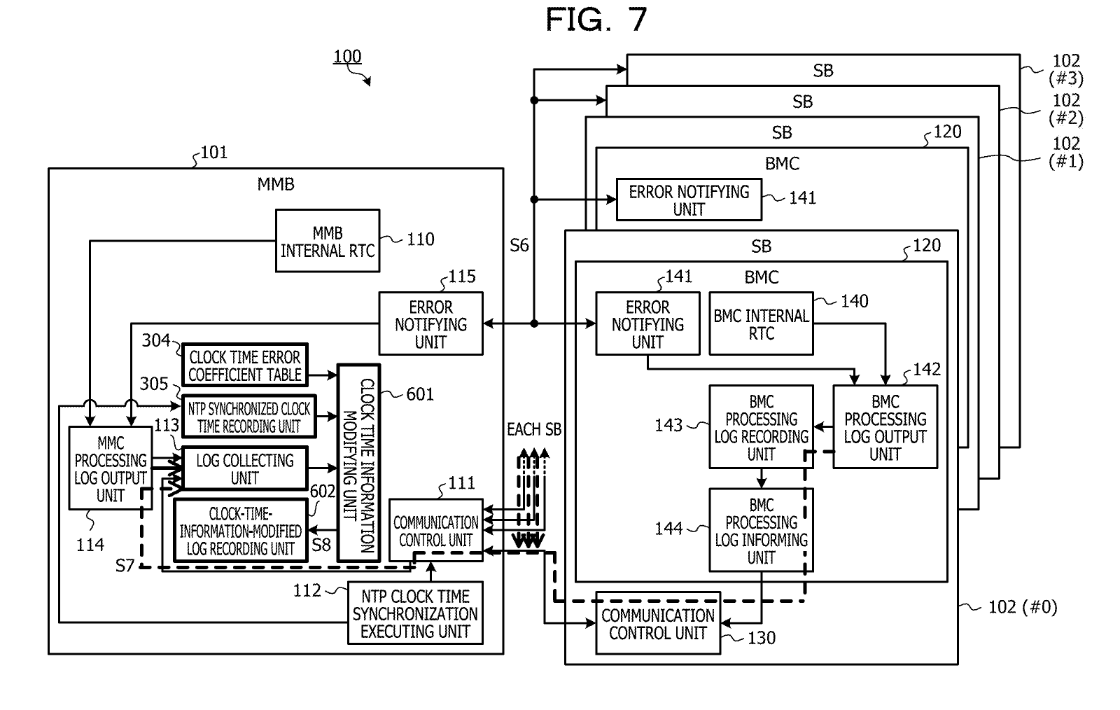

FIG. 7 is an operation explanatory diagram of clock time information modification processing in the embodiment of the information processing apparatus 100 of FIG. 6.

First, when an error occurs in any SB 102, the error notifying unit 141 in the BMC 120 of the SB 102 notifies the error to the MMB 101 and the BMCs 120 in the other SBs 102 by a signal line for error notification (S6 in FIG. 7).

The BMC processing log output unit 142 in the BMC 120 collects logs in the SB 102 including the error notification in the error notifying unit 141 and dumps the logs to the BMC processing log recording unit 143. At this time, the BMC processing log output unit 142 measures the clock time that synchronizes with the clock generated by the BMC internal RTC 140 and records the clock time as the above-described log. The BMC processing log informing unit 144 transfers the logs recorded in the BMC processing log recording unit 143 to the MMB 101 through the communication control unit 130. In the MMB 101, the log collecting unit 113 collects logs relating to each SB 102 from the BMC processing log informing unit 144 in the BMC 120 of each SB 102 through the communication control unit 130 and the communication control unit 111 and records the logs (the above corresponds to S7 in FIG. 7).

Next, the clock time information modifying unit 601 in the MMB 101 carries out two stages of deviation correction of the clock time error, for example, shift correction and prediction correction, for pieces of clock time information subsequent to a clock time T_{latestNTP} that is recorded in the NTP synchronized clock time recording unit 305 and has been subjected to NTP synchronization immediately previously among pieces of clock time information of the logs that have been measured in synchronization with the BMC internal RTC 140 in the respective BMCs 120 and have been recorded by the log collecting unit 113.

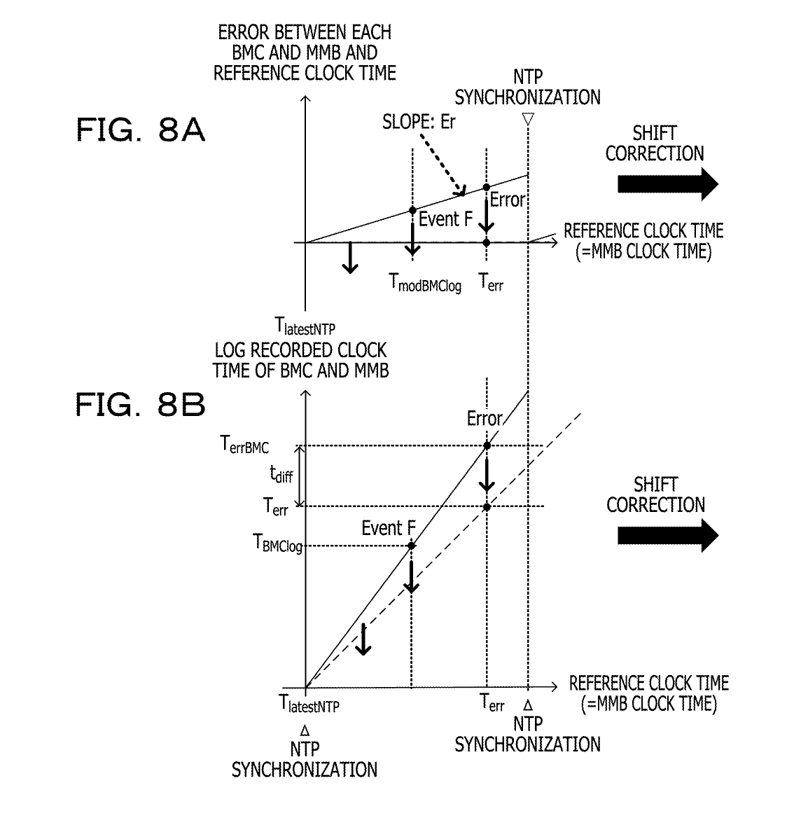

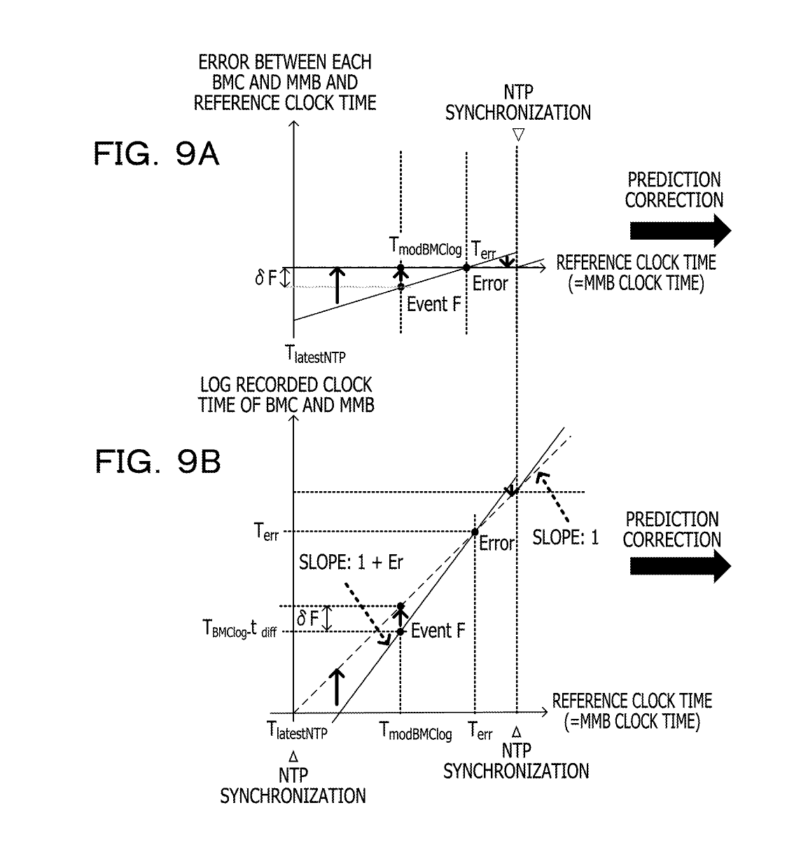

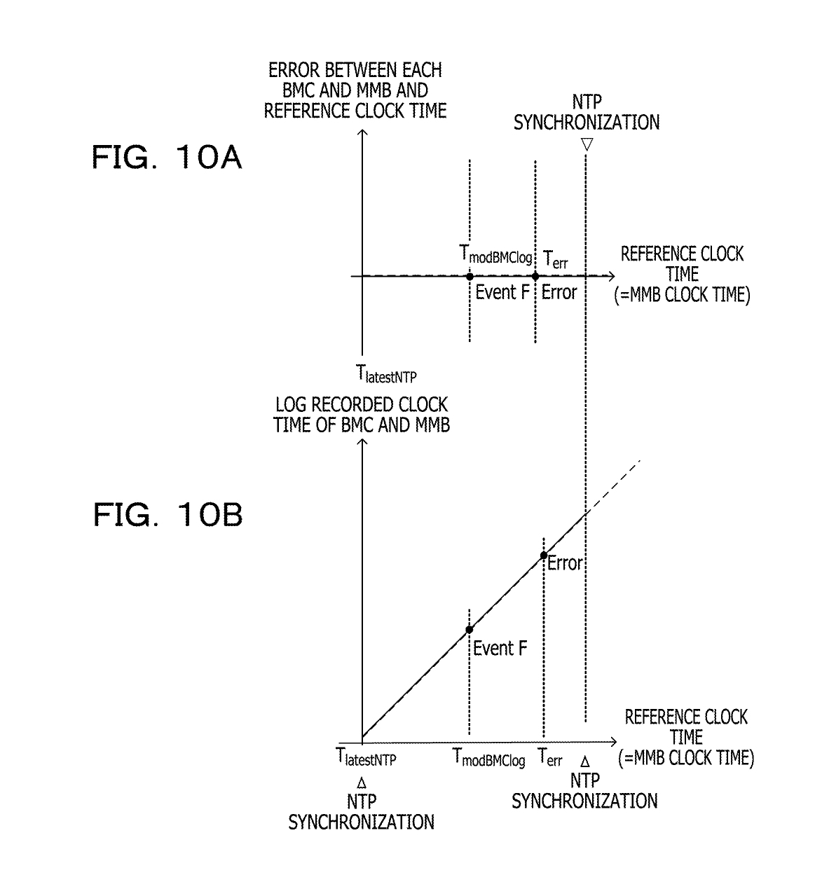

FIGS. 8A and 8B are relationship diagram between the reference clock time and the error before correction and a relationship diagram between the reference clock time and the log recorded clock time before the correction. FIGS. 9A and 9B are relationship diagram between the reference clock time and the error after shift correction and a relationship diagram between the reference clock time and the log recorded clock time after the shift correction. FIGS. 10A and 10B are relationship diagram between the reference clock time and the error after prediction correction and a relationship diagram between the reference clock time and the log recorded clock time after the prediction correction. Here, the reference clock time is the clock time measured in synchronization with the MMB internal RTC 110 of the MMB 101. The shift correction is correction to adjust the error clock time measured in the BMC 120 at the time of error occurrence to the reference clock time of the timing of the error occurrence. Furthermore, the prediction correction is correction by which a corrected value is predicted from the error/accuracy of the RTC at the timing separate from the timing of the error occurrence by Er calculated based on arithmetic processing corresponding to expression (1) by the above-described clock time error calculation processing. With only the shift correction, although the clock time of the timing when the error has occurred is correctly corrected, deviation is caused regarding a time separate from the clock time of the timing of the error occurrence. Furthermore, the value obtained by the prediction correction is a predicted value. Thus, with only the prediction correction, there is a possibility that the amount of corrected clock time becomes large depending on the error occurrence clock time and an error due to the prediction correction is caused. For this reason, it is effective to carry out two stages of correction, the shift correction and the prediction correction, to accurately correct the clock time error around the error that is most desired to be known.

First, shift correction processing will be described. When the reference clock time measured by the error notifying unit 115 of the MMB 101 at the time of error occurrence is defined as Tₑᵣᵣ and a clock time measured and recorded by the BMC 120 at the time of the error occurrence is defined as T_{errBMC} the shift correction processing is processing of subtracting a difference clock time t_{diff} between Tₑᵣᵣ and T_{errBMC} calculated based on the following expression (2) from the clock time information of each log (FIG. 8A to FIG. 9A, FIG. 8B to FIG. 9B).

t_{diff}=T_{errBMC}−Tₑᵣᵣ (2)

Due to this, the clock time measured by the MMB 101 at the timing of the error occurrence corresponds with the clock time measured by the BMC 120. Thus, the clock time and time-series information around the error occurrence deviated due to the error attributed to clock loss and the accuracy of the RTC become accurate values.

However, with only the shift of the whole, the clock time deviation of the log at a timing Event F temporally separate from the error occurrence still remains (δF in FIGS. 9A and 9B). Therefore, the prediction correction described below is carried out. By using the clock time error coefficient Er calculated based on calculation of expression (1) in the above-described clock time error calculation processing, the log of the separate time may also be allowed to have accurate clock time information. In the present embodiment, the clock time error increases in proportion to the time in the cycle of the NTP synchronization and the slope from Event F to the error occurrence in FIG. 9B is 1+Er. From these relationships, a clock time T_{modBMClog} after correction calculated by the clock time information modifying unit 601 may be calculated by calculation of the following expression (3) by using the clock time error coefficient Er, the clock time T_{errBMC} measured and recorded by the BMC 120 at the time of the error occurrence, and a log clock time T_{Bmclog} measured and recorded by the BMC 120 at the time of the occurrence of Event F.

$$( 1 + {E}_{r} ) ( {T}_{err} - {T}_{modBMClog} ) = {T}_{err} - ( {T}_{BMClog} - {t}_{diff} ) \\ \begin{matrix}{T}_{modBMClog} = {T}_{err} + \frac{{T}_{BMClog} - {t}_{diff} - {T}_{err}}{1 + {E}_{r}} \\ = {T}_{err} + \frac{{T}_{BMClog} - {T}_{errBMC}}{1 + {E}_{r}}\end{matrix} \qquad ( 3 )$$

On the first row of expression (3), “(Tₑᵣᵣ−T_{modBMClog})” of the left side represents the difference clock time between the error occurrence clock time and the log clock time (after-correction clock time) on the axis of the reference clock time in FIG. 9B. Furthermore, “(Tₑᵣᵣ−(T_{BMClog}−t_{diff}))” of the right side represents the difference clock time between the error occurrence clock time and the log clock time (resulting from subtraction of t_{diff} due to the shift correction) on the axis of the recorded clock time in the BMC 120 after the shift correction. The difference clock time on the axis of the recorded clock time in the BMC 120 is equal to the value obtained by multiplying the difference clock time on the axis of the reference clock time by the value equivalent to the slope (1+Er). For example, the slope 1+Er of the straight line is given by dividing (Tₑᵣᵣ−(T_{BMClog}−t_{diff})) by (Tₑᵣᵣ−T_{modBMClog}). Due to this, by transforming the expression as represented on the second row and the third row of expression (3), it becomes possible to calculate the clock time T_{modBMClog} after the correction by calculation corresponding to the expression of the third row.

By this prediction correction processing, the deviation between the log clock time and the reference clock time disappears (FIG. 9A to FIG. 10A, FIG. 9B to FIG. 10B).

In FIG. 8B, FIG. 9B, and FIG. 10B, the dashed line represents the clock time relationship corresponding to the MMB 101 and the slope of the dashed line is 1. If the slope of the solid line representing the clock time relationship corresponding to the BMC 120 is larger than the slope of the dashed line, the lines indicate that the progress of time is faster in the clock time of the BMC 120 than in the clock time of the MMB 101. Conversely, if the slope of the solid line representing the clock time relationship corresponding to the BMC 120 is smaller than the slope of the dashed line, the lines indicate that the progress of time is slower in the clock time of the BMC 120 than in the clock time of the MMB 101. The slope of the solid line is what is obtained by adding the clock time error coefficient Er to the slope of the reference clock time of the dashed line.

The clock time information modifying unit 601 in FIG. 6 and FIG. 7 executes the above-described two stages of correction processing for the respective logs that have been notified from each BMC 120 and have been collected and recorded by the log collecting unit 113, and records the execution result in the clock-time-information-modified log recording unit 602. This makes it possible to correct the clock time error between the MMB 101 and each BMC 120 regarding a time around an error in the NTP synchronization cycle and times separate from the error clock time and add clock time information accurately synchronized among the respective pieces of firmware (SBs 102).

In the above-described clock time information modification processing, the clock time information is not corrected about logs before the immediately-previous NTP synchronized clock time T_{latestNTP}. However, because a log desired to be seen with attention is immediately before start of log dump attributed to an error or the like, the necessity for high-accuracy synchronization is thought to be low regarding a log of a place temporally separate to some extent. If information previous to synchronization is also desired, log dump may be carried out immediately before NTP synchronization each time and the clock time information may be acquired.

According to the embodiment described above, by carrying out the two-stage correction of the shift correction and the prediction correction for the clock time information of logs measured and recorded by each BMC 120 in synchronization with the BMC internal RTC 140, the correction may be carried out with high accuracy after log collection in the MMB 101. Due to this, even if a large number of pieces of firmware exist, it is unnecessary to impose communication load and processing load due to establishment of clock time synchronization at a high frequency based on the NTP or the like and it becomes possible to obtain logs for which clock time synchronization is established with high accuracy among the pieces of firmware. Moreover, because the time information of logs is recorded, the present embodiment may be carried out when the communication load or the processing load is not excessive.

As described above, an event is notified from the MMB 101 to the BMC 120 through the hard signal line. Next, the clock time when the event is caused to occur (notified) is measured in both the MMB 101 and the BMC 120. Because delay of the clock time in the hard signal hardly exists, the difference between the clock times calculated in both is almost equal to the error between the clocks of both. Therefore, it becomes possible to calculate the error in the clock on the order of milliseconds or shorter. For example, if an event is notified by a LAN, it is difficult to calculate the error in the clock on the order of milliseconds or shorter because transmission delay in the LAN is unignorable.

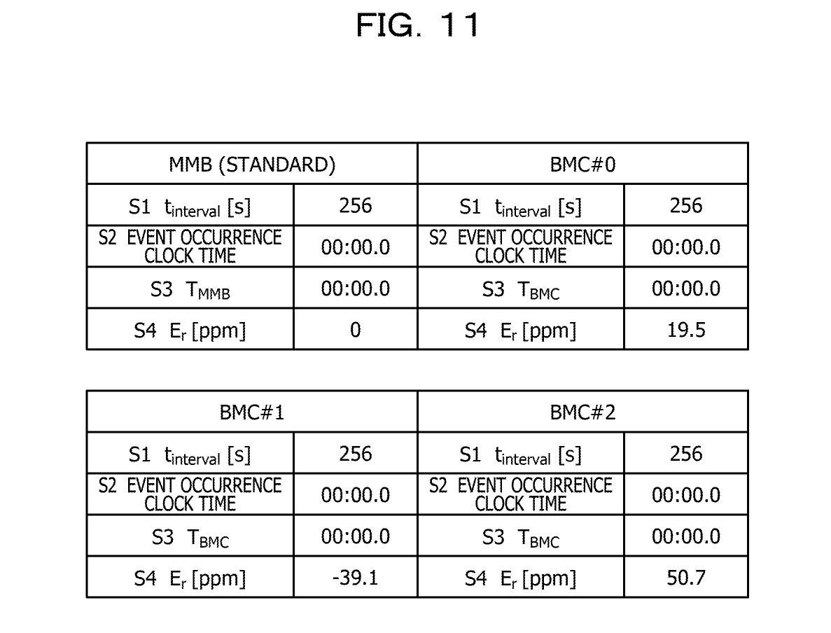

As a concrete operation example of the above-described embodiment, operation example 1 of the case in which the clock time of the MMB 101 is employed as the reference clock time and three BMCs 120 of #0 to #2 exist is illustrated in FIG. 11. Because calculated values with the unit of milliseconds (ms) are important, the calculated values are represented with omission of date recording in the following description. S1 to S4 in operation example 1 illustrated in FIG. 11 correspond to the operation example of S1 to S4 in FIG. 4 and the meanings of S1 to S4 are as follows.

S1: synchronization is started with the NTP clock time synchronization interval tᵢₙₜₑᵣᵥₐₗ set to 256.000 sec.

S2: the case in which an event is caused to occur with the event occurrence clock time set to 00:00:00.000 of every day is considered.

S3: the occurrence clock time of the common event that is measured in the MMB 101 and is recorded in the common event clock time table 302 at the time is T_{MMB} and the occurrence clock time of the common event that is measured in the respective BMCs 120 of #0 to #2 and is recorded in the common event clock time table 302 is T_{BMC}.

S4: the clock time error coefficient calculated by the clock time error coefficient calculating unit 303 is Er.

Moreover, as a procedure S5, the above procedures of S1 to S4 are similarly repeated also at 00:04:16.000 after 256 sec and at 00:08:32.000 after 512 sec and the clock time error coefficient table 304 is updated with the average of these three times of repetition. In this example, it is assumed that Er is the same value in the three times of calculation for simplification.

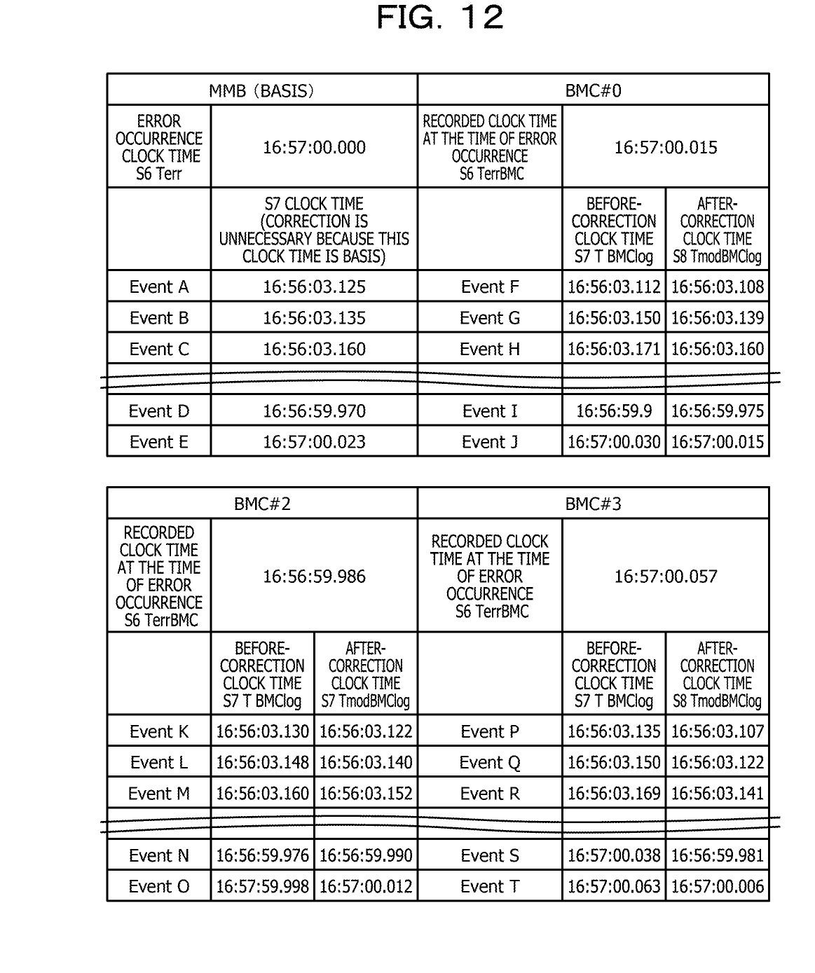

Next, operation example 2 at the time of log collection is illustrated in FIGS. 12. S6 to S8 in operation example 2 illustrated in FIG. 12 correspond to the operation of S6 to S8 in FIG. 7 and the meanings of S6 to S8 are as follows.

S6: an error occurs at Tₑᵣᵣ=16:57:00.000 and the error occurrence clock time recorded by the respective pieces of firmware (BMCs 120) at the time is T_{errBMC}=16:57:00.015.

S7: logs are collected in subsequent several minutes and each BMC processing log informing unit 144 sends the logs to the log collecting unit 113. The before-correction clock time is T_{BMClog}.

S8: the result of execution of correction for the before-correction clock time T_{BMClog} of the log is the after-correction clock time T_{modBMCLog}.

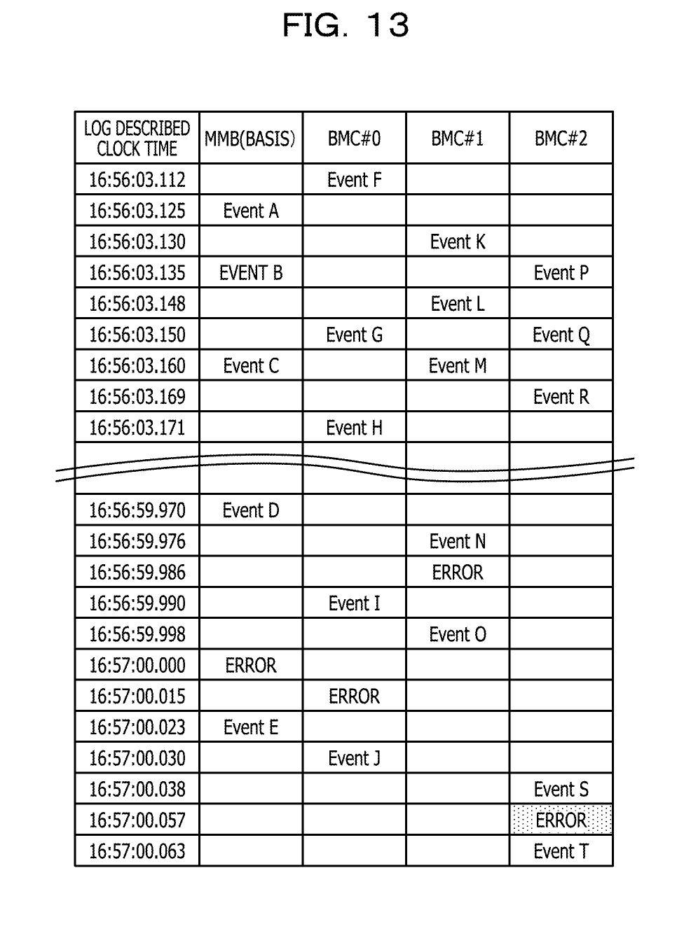

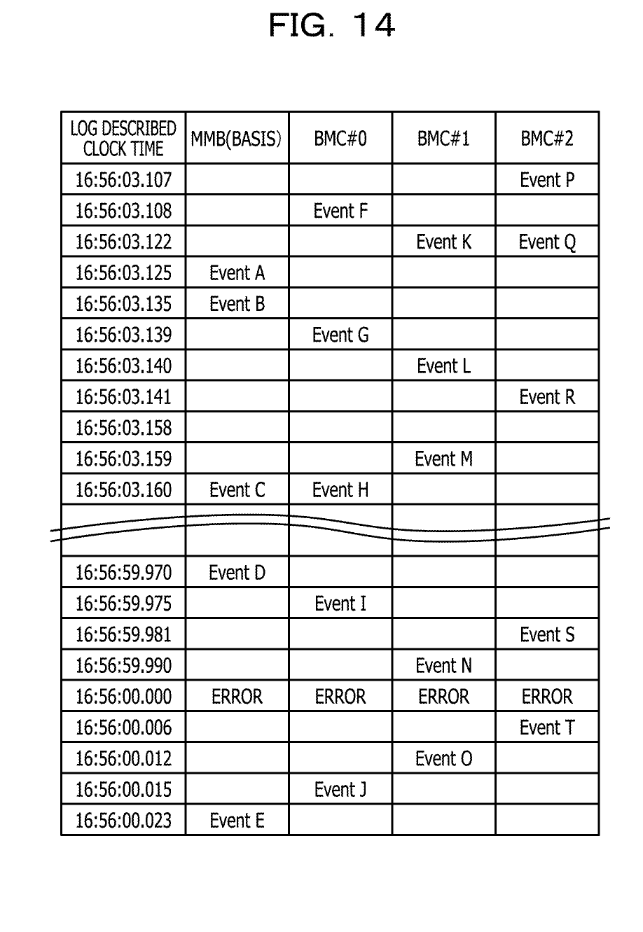

At last, an example of the log time series before the clock time correction corresponding to operation example 2 of FIG. 12 is illustrated in FIG. 13 and an example of the log time series after the clock time correction is illustrated in FIG. 14. It turns out that, by the clock time correction operation from FIG. 13 to FIG. 14, the clock times measured and logged by the BMC internal RTC 140 of each BMC 120 are corrected to be rearranged into the time series of the accurate clock times.

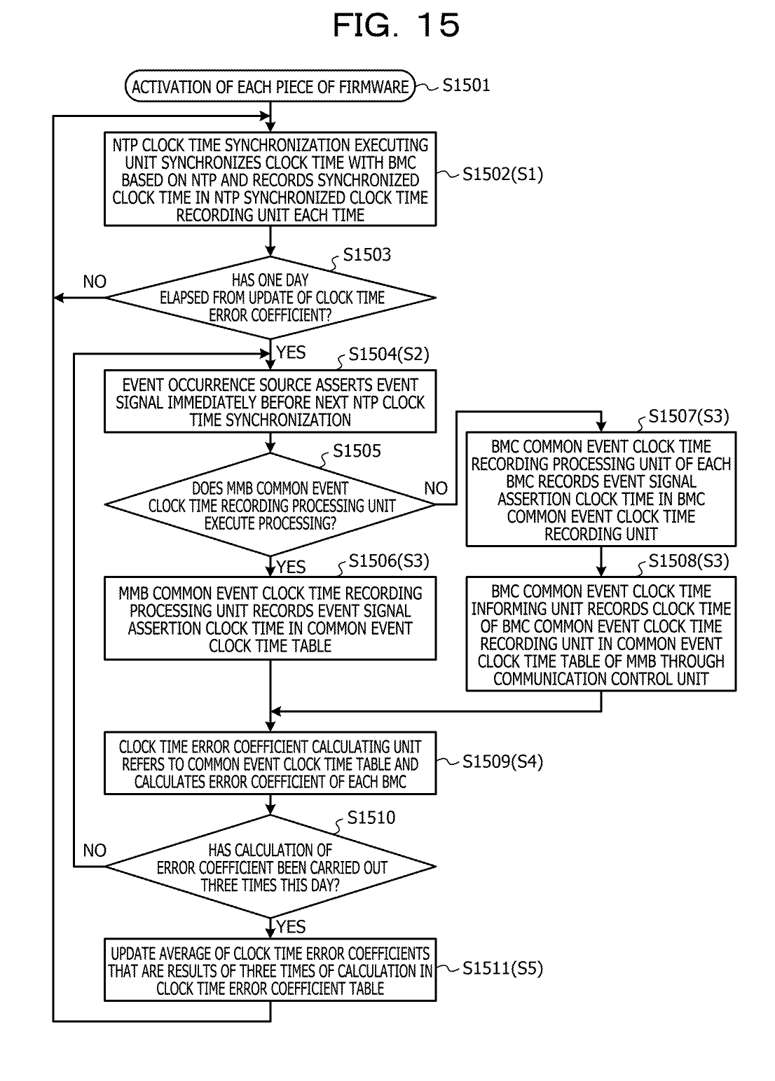

FIG. 15 is a flowchart illustrating a processing example in the case in which the clock time error calculation processing that is executed based on the configuration example of FIG. 3 and is illustrated in FIG. 4 is executed as software processing. This processing is processing in which the processor of the MMB 101 and the processors of the respective BMCs 120 each execute firmware (program). In the flowchart of FIG. 15, reference symbols of S1 to S5 in parentheses indicate that the steps are processing corresponding to the operation of S1 to S5 in the operation explanation of the above-described FIG. 4.

The firmware of the MMB 101 and the firmware of each BMC 120 are activated and thereby the processing of this flowchart starts (step S1501 in FIG. 15).

First, the NTP clock time synchronization executing unit 112 of the MMB 101 establishes clock time synchronization with the time clock that operates in synchronization with the BMC internal RTC 140 in the BMC 120 of each SB 102 as an NTP server. The NTP clock time synchronization executing unit 112 records the synchronized clock time in the NTP synchronized clock time recording unit 305 each time (step S1502 in FIG. 15) (51 in FIG. 4).

Next, whether or not one day has elapsed from update of the clock time error coefficient is determined (step S1503 in FIG. 15).

If the determination result of the step S1503 is No, return to the processing of the step S1502 is made.

If the determination result of the step S1503 is Yes, the event occurrence source 300 asserts a common event signal immediately before the next synchronization processing by the NTP clock time synchronization executing unit 112 (step S1504 in FIG. 15) (S2 in FIG. 4).

Next, if the MMB common event clock time recording processing unit 301 detects the assertion of the above-described common event signal (determination result of the step S1505 in FIG. 15 is Yes), the following processing is executed. The MMB common event clock time recording processing unit 301 measures the clock time when the common event has been asserted (occurrence clock time of the common event) by the time clock that synchronizes with the MMB internal RTC 110, and records the clock time in the common event clock time table 302 (step S1506 in FIG. 15) (S3 in FIG. 4).

On the other hand, if the BMC common event clock time recording processing unit 310 of each BMC 120 detects the assertion of the above-described common event signal (determination result of the step S1505 in FIG. 15 is No), the following processing is executed. The BMC common event clock time recording processing unit 310 measures the clock time when the common event has been asserted (occurrence clock time of the common event) by the time clock that synchronizes with the BMC internal RTC 140, and dumps the clock time to the BMC common event clock time recording unit 311 (step S1507 in FIG. 15) (S3 in FIG. 4).

The common event clock time informing unit 312 notifies the MMB 101 of the occurrence clock time of the common event dumped to the above-described BMC common event clock time recording unit 311 through the communication control unit 130. The MMB 101 records the occurrence clock time of the common event notified from each BMC 120 in the common event clock time table 302 (step S1508 in FIG. 15) (S3 in FIG. 4).

After the step S1506 or S1508, the clock time error coefficient calculating unit 303 in the MMB 101 calculates the clock time error coefficient of each BMC 120 from the above-described two occurrence clock times of the common event in the common event clock time table 302 (step S1509 in FIG. 15) (S4 in FIG. 4).

Thereafter, whether or not the calculation of the above-described clock time error coefficient has been carried out three times this day is determined (step S1510 in FIG. 15).

If the determination result of the step S1510 is No, return to the processing of the step S1504 is made.

If the determination result of the step S1510 becomes Yes, the clock time error coefficient calculating unit 303 calculates the average of the clock time error coefficients that are the results of the three times of calculation and updates the stored contents of the clock time error coefficient table 304 with the value (step S1511 in FIG. 15) (S5 in FIG. 4).

Thereafter, return to the processing of the step S1502 is made.

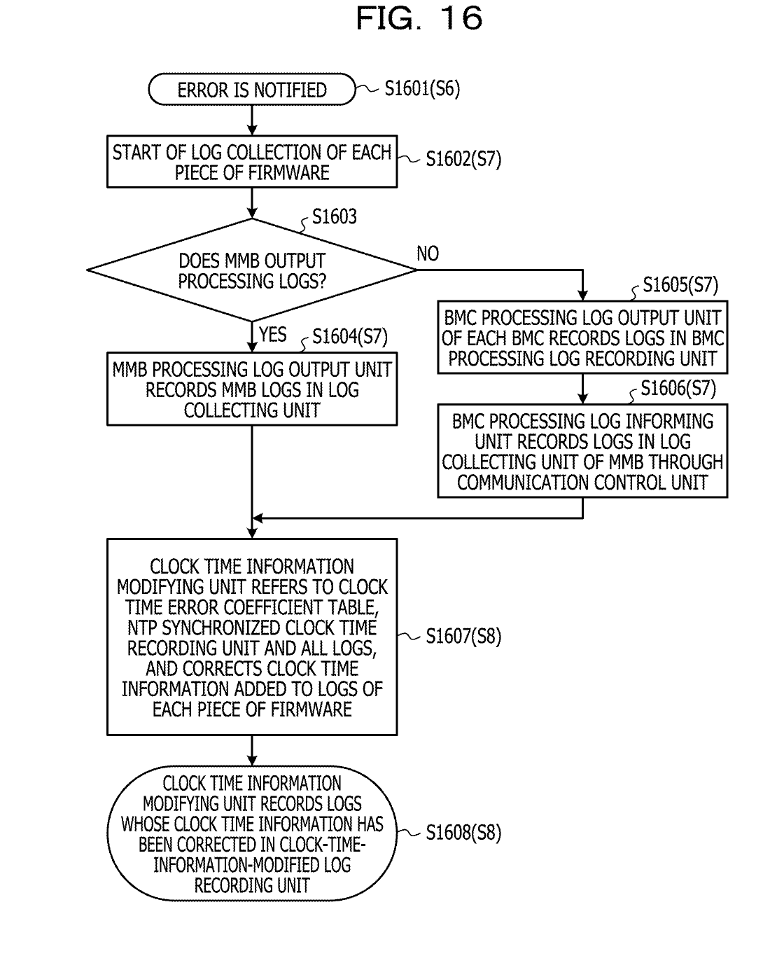

FIG. 16 is a flowchart illustrating a processing example in the case in which the clock time information modification processing that is executed based on the configuration example of FIG. 6 and is illustrated in FIG. 7 is executed as software processing. This processing is processing in which the processor of the MMB 101 and the processors of the respective BMCs 120 each execute firmware. In the flowchart of FIG. 16, reference symbols of S6 to S8 in parentheses indicate that the steps are processing corresponding to the operation of S6 to S8 in the operation explanation of the above-described FIG. 7.

When an error occurs in any SB 102, the error notifying unit 141 in the BMC 120 of the SB 102 notifies the error to the MMB 101 and the BMCs 120 in the other SBs 102 by the signal line for error notification. As a result, the processing of this flowchart starts (step S1601 in FIG. 16) (S6 in FIG. 7).

The MMB processing log output unit 114 or the BMC processing log output unit 142 of each piece of firmware (MMB 101 or BMC 120) starts collection of error logs (step S1602 in FIG. 16) (S7 in FIG. 7).

If the MMB 101 outputs processing logs (determination result of the step S1603 in FIG. 16 is Yes), the MMB processing log output unit 114 records logs relating to the error in the MMB 101 in the log collecting unit 113 (step S1604 in FIG. 16) (S7 in FIG. 7).

If the BMC 120 outputs processing logs (determination result of the step S1603 in FIG. 16 is No), the BMC processing log output unit 142 records logs relating to the error in the BMC 120 in the BMC processing log recording unit 143 (step S1605 in FIG. 16) (S7 in FIG. 7).

The BMC processing log informing unit 144 transfers the error logs recorded in the BMC processing log recording unit 143 to the MMB 101 through the communication control unit 130. In the MMB 101, the log collecting unit 113 collects and records the error logs relating to each SB 102 from the BMC processing log informing unit 144 in the BMC 120 of each SB 102 through the communication control unit 130 and the communication control unit 111 (step S1606 in FIG. 16) (S7 in FIG. 7).

After the step S1604 or S1606, the clock time information modifying unit 601 in the MMB 101 executes the following processing. The clock time information modifying unit 601 refers to the clock time error coefficient table 304, the NTP synchronized clock time recording unit 305, and each piece of log information collected by the log collecting unit 113 and modifies the clock time information added to the logs of each piece of firmware (BMC 120) (step S1607 in FIG. 16) (S8 in FIG. 7). For example, as described above in the explanation of FIG. 7, the clock time information modifying unit 601 carries out two stages of deviation correction of the clock time error, for example, the shift correction and the prediction correction, for pieces of clock time information subsequent to the clock time T_{latestNTP} that is recorded in the NTP synchronized clock time recording unit 305 and has been subjected to NTP synchronization immediately previously among pieces of clock time information of the logs that have been measured in synchronization with the BMC internal RTC 140 in the respective BMCs 120 and have been recorded by the log collecting unit 113.

At last, the clock time information modifying unit 601 records the logs whose clock time information has been corrected in the clock-time-information-modified log recording unit 602 (step S1608 in FIG. 16) (S8 in FIG. 7).

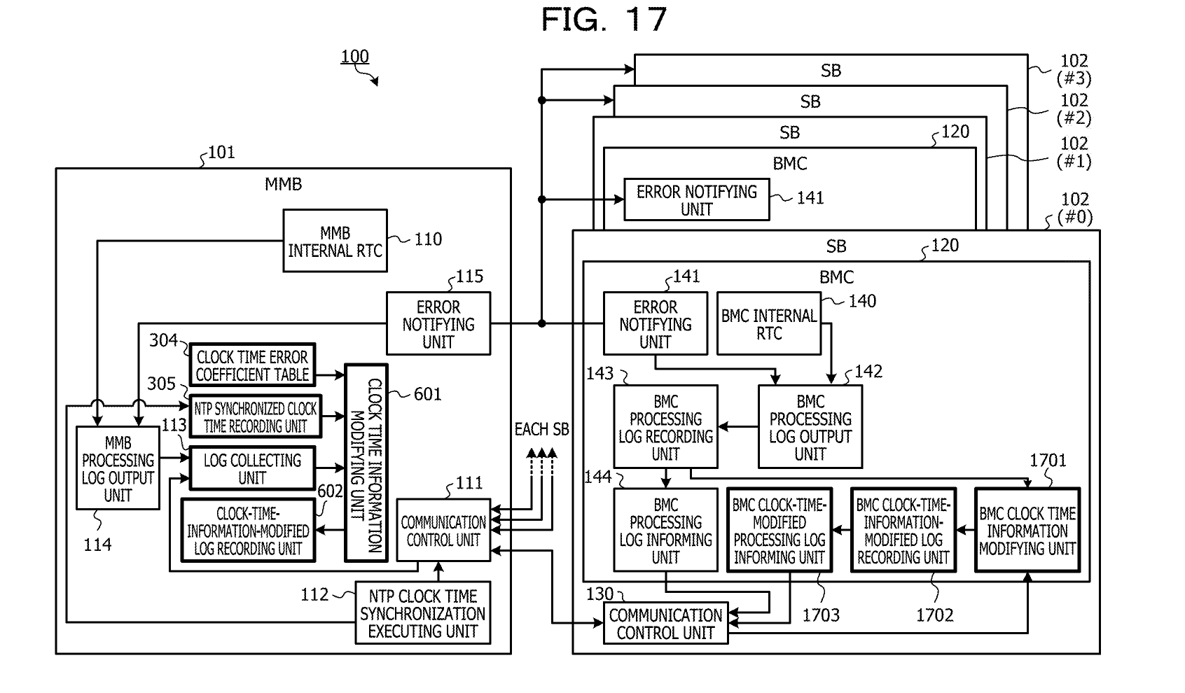

FIG. 17 is a diagram illustrating a configuration example of another embodiment of the information processing apparatus for implementing the operation of the clock time information modifying part. If the number of logs is large and the processing of the MMB 101 increases due to a large number of BMCs 120 or the like in the embodiment to implement the operation of the clock time information modifying part described with FIG. 6 and FIG. 7, it is preferable to cause part of the functions of the clock time information modifying part to be possessed by not the MMB 101 but each BMC 120 in a distributed manner. The configuration of FIG. 17 implements this function distribution and each BMC 120 newly includes a BMC clock time information modifying unit 1701, a BMC clock-time-information-modified log recording unit 1702, and a BMC clock-time-modified processing log informing unit 1703. The other configuration is similar to the case of FIG. 6.

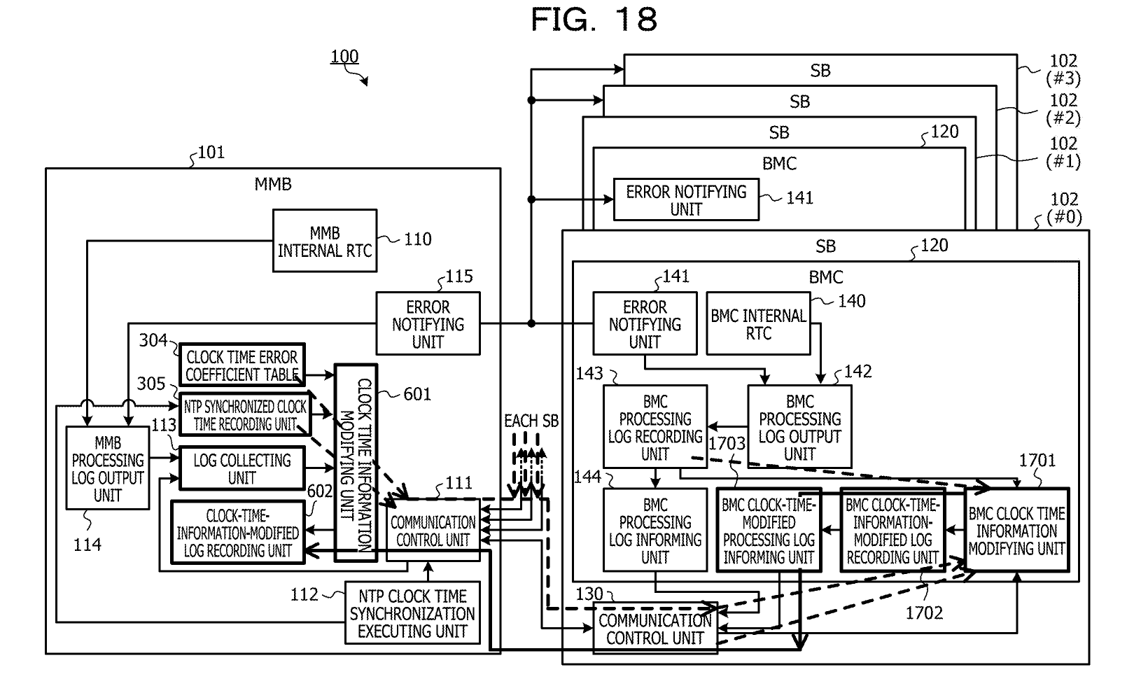

FIG. 18 is an operation explanatory diagram of the configuration of FIG. 17. The BMC clock time information modifying unit 1701 in the BMC 120 receives the clock time error coefficient relating to the self-device from the clock time error coefficient table 304 in the MMB 101 and receives the immediately-previous NTP synchronized clock time from the NTP synchronized clock time recording unit 305 (S9).

Based on the above-described information, the BMC clock time information modifying unit 1701 modifies the clock time information of logs having clock times that are recorded in the BMC processing log recording unit 143 and are subsequent to the immediately-previous NTP synchronized clock time similarly to the case of the clock time information modifying unit 601 in the above-described MMB 101. The BMC clock time information modifying unit 1701 records the logs whose clock time information has been modified in the BMC clock-time-information-modified log recording unit 1702. The BMC clock-time-modified pocessing log informing unit 1703 transfers the logs that have been recorded in the BMC clock-time-information-modified log recording unit 1702 and whose clock time information has been modified to the MMB 101 through the communication control unit 130. The MMB 101 records the transferred logs in the clock-time-information-modified log recording unit 602 (the above corresponds to S10).

According to the other embodiment of the above FIG. 17 and FIG. 18, when the BMCs 120 increase, it becomes possible to reduce the processing load of the MMB 101 by causing the clock time information modification processing to be executed by each BMC 120 in a distributed manner.

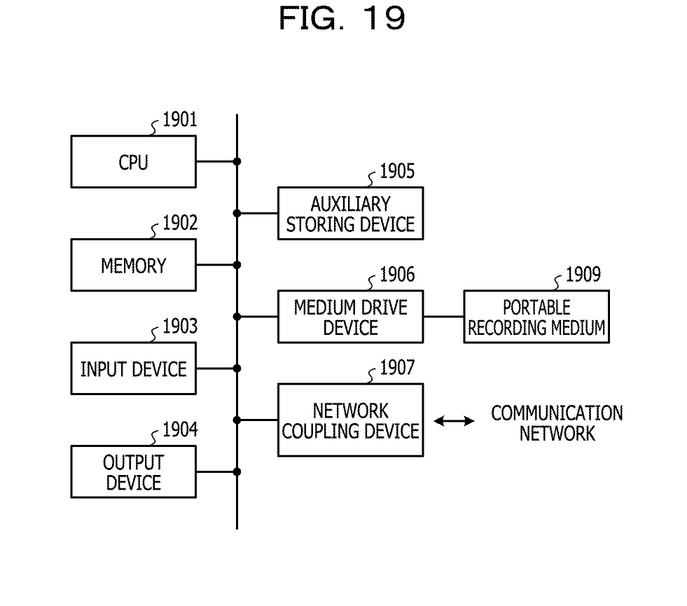

FIG. 19 is a diagram illustrating one example of the hardware configuration of the information processing apparatus (computer) of FIG. 1 or FIG. 17.

The computer illustrated in FIG. 19 includes a CPU 1901, a memory 1902, an input device 1903, an output device 1904, an auxiliary storing device 1905, a medium drive device 1906 in which a portable recording medium 1909 is inserted, and a network coupling device 1907. These constituent elements are mutually coupled by a bus 1908. The configuration illustrated in FIG. 19 is one example of a computer that may implement the above-described information processing apparatus and such a computer is not limited to this configuration.

The memory 1902 is a semiconductor memory such as a read only memory (ROM), a random access memory (RAM), or a flash memory and stores programs and data used for processing.

The CPU (processor) 1901 executes a program by using the memory 1902 and thereby operates as the respective processing units of the MMB 101 or the respective processing units in the BMC 120 in FIG. 1, for example.

The input device 1903 is a keyboard, a pointing device, and so forth, and is used for input of instructions from an operator or user or information. The output device 1904 is a display device, a printer, a speaker, and so forth and is used for output of inquiries to an operator or user or a processing result.

The auxiliary storing device 1905 is a hard disk storing device, a magnetic disk storing device, an optical disk device, a magneto-optical disk device, a tape device, or a semiconductor storing device, for example. The information processing apparatus 100 of FIG. 1 or FIG. 17 may store program and data in the auxiliary storing device 1905 and load the program and data into the memory 1902 to use the program and data.

The medium drive device 1906 drives the portable recording medium 1909 and accesses the recorded contents thereof. The portable recording medium 1909 is a memory device, a flexible disk, an optical disk, a magneto-optical disk, or the like. The portable recording medium 1909 may be a compact disk read only memory (CD-ROM), a digital versatile disk (DVD), a universal serial bus (USB) memory, or the like. An operator or user may store program and data in this portable recording medium 1909 and load the program and data into the memory 1902 to use the program and data.

As above, the computer-readable recording medium that stores program and data used for processing of the information processing apparatus 100 of FIG. 1 or FIG. 17 is a physical (non-transitory) recording medium like the memory 1902, the auxiliary storing device 1905, or the portable recording medium 1909.

The network coupling device 1907 is a communication interface that is coupled to a communication network such as a LAN, and carries out data conversion accompanying communication. The network coupling device 1907 operates as the communication control unit 111 or 130 in FIG. 1 or FIG. 17. The information processing apparatus 100 of FIG. 1 or FIG. 17 may receive a program or data from an external apparatus through the network coupling device 1907 and load the program or data into the memory 1902 to use the program or data.

The information processing apparatus 100 of FIG. 1 or FIG. 17 does not need to include all constituent elements in FIG. 19 and it is also possible to omit part of the constituent elements according to the use purpose or condition. For example, the input device 1903 may be omitted if it is unnecessary to input instructions from an operator or user or information. The medium drive device 1906 may be omitted if the portable recording medium 1909 is not used.

Although the disclosed embodiments and advantages thereof are described in detail, those skilled in the art may make various kinds of change, addition, and omission without departing from the range of the present disclosure clearly set forth in the scope of claims.

According to the respective embodiments described above, it becomes possible to carry out more accurate clock time correction without increasing the frequency of NTP synchronization in an information processing apparatus in which synchronization of plural clock times is desired.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first circuit configured to operate in synchronization with a clock time of the first circuit;
a second circuit configured to operate in synchronization with a clock time of the second circuit and control the first circuit;
a first memory; and
a first processor coupled to the memory and configured to:
when a first clock time of the first circuit is synchronized with a second clock time of the second circuit or a reference clock time, calculate a coefficient for clock time correction according to change in a difference between at least one of the first clock time and the second clock time and the reference clock time, and
correct clock time information of logs collected by the second circuit based on the coefficient.

2. The information processing apparatus according to claim 1, wherein the first processor corrects a clock time error of the first circuit at a timing of error occurrence to the second clock time or the reference clock time at the timing of error occurrence.

3. The information processing apparatus according to claim 2, wherein the first processor corrects a clock time error at a clock time separate from the timing of error occurrence by a given value or longer to the second clock time or the reference clock time based on the coefficient for clock time correction.

4. The information processing apparatus according to claim 1, wherein the first processor calculates the coefficient for clock time correction by notifying occurrence of an event from the second circuit to the first circuit through a signal line before execution of the synchronization and dividing a difference clock time between an occurrence clock time of the event measured in the first circuit and an occurrence clock time of the event measured in the second circuit by a given cycle.

5. The information processing apparatus according to claim 1, wherein
the second circuit includes:
a second memory; and
a second processor coupled to the second memory and configured to:
notify occurrence of an event to each of the first circuits through a signal line,
record an occurrence clock time of the event,
store, in the second memory, the occurrence clock time of the event that is recorded and occurrence clock times of the event each measured in a respective one of the first circuits, and
calculate the coefficient for clock time correction based on the occurrence clock times that are stored.

6. The information processing apparatus according to claim 1, wherein the coefficient is a slope of a straight line.

7. The information processing apparatus according to claim 1, wherein the first and second circuits are circuits each implemented by execution of firmware by the first processor.

8. The information processing apparatus according to claim 1, wherein the first circuit receives a clock time error corresponding to the first clock time from the second circuit and corrects clock time information of logs collected by the first circuit.

9. An information processing method for an information processing apparatus including a first circuit that operates in synchronization with a clock time of the first circuit and a second circuit that operates in synchronization with a clock time of the second circuit and controls the first circuit, the information processing method comprising:
when a first clock time of the first circuit is synchronized with a second clock time of the second circuit or a reference clock time, calculating a coefficient for clock time correction according to change in a difference between at least one of the first clock time and the second clock time and the reference clock time; and
correcting clock time information of logs collected by the second circuit based on the coefficient.
